(19) United States
(12) Patent Application Publication
(10) Pub. No.: US 2018/0244362 A1
(43) Pub. Date: Aug. 30, 2018

(54) SMART MARINE THROTTLE

(71) Applicant: BAE Systems Land & Armaments L.P., Arlington, VA (US)

(72) Inventors: James R. Nolan, Boulder Creek, CA (US); Hei Shea, Newark, CA (US); Peter C. Chu, San Mateo, CA (US); Brett E. Nibbelink, San Jose, CA (US)

(21) Appl. No.: 15/905,316

(22) Filed: Feb. 26, 2018

Related U.S. Application Data
(60) Provisional application No. 62/463,196, filed on Feb. 24, 2017.

(51) Int. Cl. B63H 25/02; B60F 3/00; B63H 25/42

(52) U.S. Cl. CPC B63H 25/02; B63H 2025/024; B63H 25/42; B60F 3/0007

(57) ABSTRACT

An amphibious vehicle having a smart marine throttle which, when enabled, will control the power to right and left propulsors. The vehicle will then be able to automatically follow a course to a predetermined destination while overcoming the effect of wind, water current and wave action. The invention also includes a method for autopiloting a marine vessel.

### RELATED APPLICATION

The present application claims the benefit of U.S. Provisional Application No. 62/463,196 entitled “SMART MARINE THROTTLE”, filed Feb. 24, 2017, which is incorporated herein by reference in its entirety.

### TECHNICAL FIELD

The present invention is generally related to a control system for a marine vessel, and in particular, to guiding a propeller driven amphibious vehicle.

### BACKGROUND OF THE INVENTION

Mobile navigation systems are used to guide a traveler to a desired destination. Generally, these systems take advantage of global positioning system (GPS) transceivers to note the location of the traveler. The location is often noted in longitude and latitude coordinates. Typically, with motorized vehicles, the directions are confined to existing roads with allowed speed limits. The system gives directions to the destination by highlighting on a map for example the optimum path.

A mobile navigation system is more complicated for marine vessels where there are no roads. While operating a marine vessel over long distances it is often hard to keep a true heading due to the influence of currents and wind forces. The difficulty is further exacerbated at night when visibility is decreased.

Vehicles such as marine vessels are often provided with varied propulsion systems. Typically they have a single propeller and direction is controlled by a rudder. Other marine vessels, including amphibious vehicle do not have a rudder. Direction is controlled by utilizing a separate shift and throttle system for each motor.

Amphibious vehicle use a standard differential throttle (port and starboard) to control the speed and direction of the water propulsors. These systems typically allow an operator to control the shift and throttle functions of a propulsion unit using a control lever which is pivotally mounted on a control head. The control lever is moveable between a forward wide open throttle (forward WOT) position and a reverse wide open throttle (reverse WOT) position, through a neutral position. A controller reads the position of the control lever as the control lever moves through its operational range. The controller sends shift commands and throttle commands which drive a shift actuator and a throttle actuator based on the position of the control lever.

There are prior art marine GPS systems, such as that provided by SBG Systems which can be used in a navigation system to provide navigation input for marine vehicles. The prior art models are typically for rudder type steering. These types of systems cannot be used when direction is controlled through the flow of water being propelled on either side of a vehicle by the setting of two control paddles.

In the marine environment, vessels are subjected to currents, sea states, weather and other maritime traffic. What is needed is a smart throttle control for rudderless marine vessels and amphibious vehicles that takes advantage of GPS as well course characteristics to optimize route and fuel consumption in these conditions.

### SUMMARY OF THE INVENTION

Amphibious vessels for military operations typically have a waterproof armored hull with at least one water propulsion means. Many such vessels have two propulsors disposed on opposing sides of the rear door. Due to the geometry of the vessel, a single rudder is not practical as it would block the rear egress hatch.

Control of amphibious vehicles is typically by a standard differential throttle (port and starboard or left and right) to control the speed and direction of the water propulsors. This throttle is adjusted forward or backward to apply power to the propellers. What is disclosed here is a smart marine throttle which will control the power to the port and starboard propulsors so that the vehicle will follow a predetermined route while taking into account currents, sea states, weather and other maritime traffic. The proposed smart throttle would modulate the differential throttle inputs to each propulsor to keep the marine vehicle underway and on course.

The proposed device combines inertial navigation systems (INS) and GPS along with the hand throttles normally used by electronically controlled marine craft propulsors. The novelty of this device is that the user can replace/upgrade their hand throttle and have the added benefit of inertial navigation and marine craft steering.

Advantages provided by the current invention include:

Augmented steering of a marine vehicle with differential propulsors;

Maintain a pre-programmed course and/or heading on Autopilot mode;

Using inertial sensors and GPS position and navigation to maintain a course and/or heading;

Using GPS also to calibrate the inertial sensors;

Provide inputs to an electronically controlled propulsor control system by means of modulating the port or starboard propulsion gains and directions; and

A remote control feature applied by a vehicle commander or via a wireless and/or via secure HF or SATCOM so that the vessel is essentially an “Unmanned Amphibious Drone”.

Some advanced features include throttle controls that allow the user to select engine controls including gear selection, etc. This invention adds the ability to auto-pilot any vehicle which can be manually piloted by controlling the hand throttles to direct the speed (flow) and direction of two propulsors on the port and starboard sides of a marine craft.

The marine craft yaw and speed will be controlled such that a heading is kept to land at a final LAT/LONG position when the autopilot is enabled. The autopilot will accomplish this by controlling the direction and speed of the vehicle by means of inertial navigation, propulsor speed control, and GPS location and navigation.

In one embodiment, to allow the autopilot system to control the propulsors on the vehicle, the user must first place both left and right propulsor controls in the middle position and then after entering valid destination coordinates the user can press the autopilot button. The smart throttle will then output signals to the navigation Vehicle Management System (VMS) that are the result of the Port and Starboard PID thrust vector algorithms. The outputs can be in any form such as analog, resistive (single or dual counter apposing), TTL digital, serial (RS-232/422), or CAN BUS.

The present invention is a throttle device for an amphibious vehicle having a port and a starboard propulsor, the throttle device including; a throttle device housing; a pair of left and right propulsor control paddles attached to the throttle device housing and operably connected to the port and starboard propulsor; an autopilot engagement switch mounted to the throttle device housing; a manual trim control switch mounted to the throttle device housing; and a power cord mounted to the throttle device housing and operably connected to an autopilot controller, wherein said autopilot controller is configured to receive a destination and to selectively control the port and starboard propulsor so as to direct the amphibious vehicle to the destination.

The throttle device further includes an interface panel on the upperface of the throttle device for programming the destination into the autopilot controller. The interface panel may include a visual display for providing information as to a location and a course, as well as other input and status options.

The throttle device further includes a cancel autopilot control switch separate from the autopilot engagement switch. This could be activated anytime during the autopilot course should conditions demand.

In an embodiment, the autopilot controller determines whether the destination is within a fuel range of the amphibious vehicle. The autopilot controller also calculates a corrected yaw heading based on wind effect, water current effect and the wave action effect. The throttle device is operably connected to a global positioning system-inertial navigation system for determining current location.

The throttle device may include an antenna connection so that the autopilot controller is operably connected through a wireless connection, a secure High Frequency connection or a satellite communication connection for receiving commands instructions to allow unmanned operation of the amphibious vehicle.

The present invention may also be a method for autopiloting an amphibious vehicle to a destination, the method comprising; activating a smart throttle having a controller, said smart throttle selectively engaging a left and a right propulsor; instructing the smart throttle as to the destination; engaging an autopilot function; calculating a course to the destination; outputting from the controller a plurality of signals to the left and right propulsors to direct the amphibious vehicle to the destination; and thereafter adjusting the course based on wind, water current and wave action.

The method further includes creating a starting set point. The starting set point is based on a destination GPS Latitude, a destination GPS Longitude, a current GPS Latitude and a current GPS Longitude. The method may further include calculating an amphibious vehicle range and comparing that range to a distance between the destination and the starting set point.

The method may include adjusting the course by factoring an X, Y and Z axis accelerometer rate and an X, Y and Z gyro roll rate to determine a current position. Course adjustment is by comparing the current position to a desired yaw heading, said current position reflecting the influences of water currents, wind and wave action. Adjusting the course further includes adjusting a speed of the amphibious vehicle. Adjustments to the course are done by the command to the left and right propulsors. Adjustments can also be done by controlling a trim control flap on the amphibious vehicle.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of the smart throttle device.

FIG. 2 is an operational schematic of the smart throttle device.

FIG. 3 is a schematic of input and outputs from the GPS-INS and Autopilot control system.

FIG. 4 is a graphical representation of the vehicle reaction to controls and environment.

FIG. 5 is a flow chart of the navigation system utilizing the present invention.

FIG. 6 is a overhead view of a simulated course.

FIG. 7 is a plot test result of corrections from an unfiltered course.

FIG. 8 is a plot test result of corrections from a filtered course.

FIG. 9 is a perspective view of an amphibious vehicle with propulsors.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

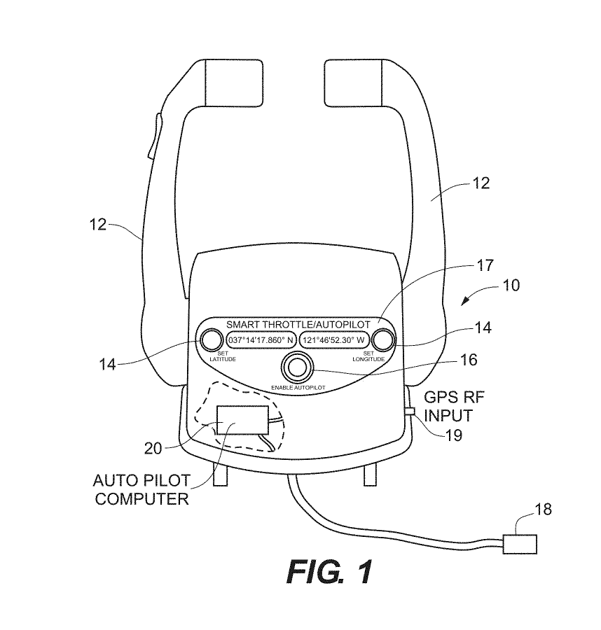

FIG. 1 illustrates the present invention. The smart throttle device 10 includes left and right speed-and-direction control paddles (handles) 12, an input section for entering the arrival latitude and longitude 14 and controls 16 to start and stop the autopilot. The interface panel 17 may also include visual screens such as compass headings. The autopilot computer (Global Positioning System-Inertial Navigation System (GPS-INS)) 20 is shown in cutaway of the throttle device housing 10. The autopilot computer 20 will allow for wireless and unmanned operations. A power cord 18 is operably connected to the autopilot computer.

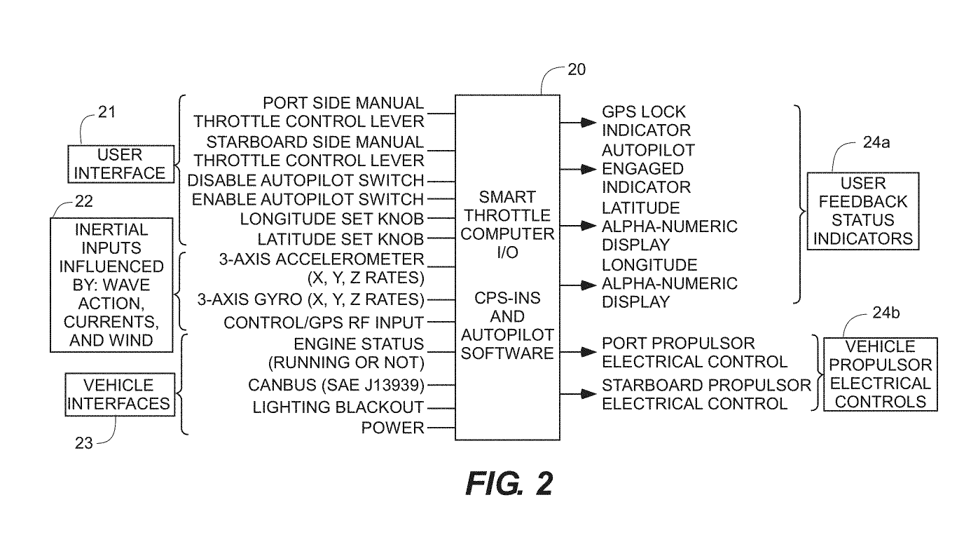

FIG. 2 depicts the some of the inputs and outputs for the autopilot computer 20. The user interfaces 21 includes: port side manual throttle control lever, starboard side manual throttle control lever, disable autopilot switch, enable autopilot switch, longitude set know, and latitude set know. Inertial inputs influenced by wave action, currents and wind 22 includes 3-axis accelerometer, 3 axis gyro, and control GPS RF input 19. Vehicle interfaces 23 includes; engine status, Canbus; lighting blackout and power. These inputs perform the basis for calculations from autopilot computer 20. The outputs from autopilot computer 20 include User feedback status indicators 24a and vehicle propulsor electrical controls 24b.

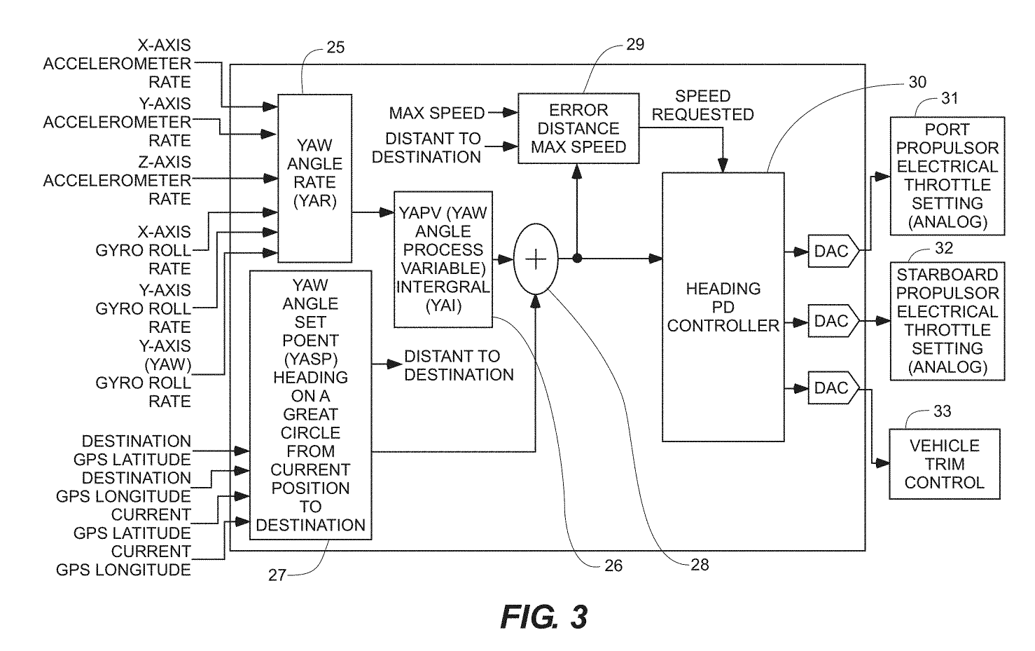

To allow the autopilot system to control the propulsors on the vehicle the user must first place both left and right propulsor controls in the middle position and then after entering valid destination coordinates the user can press the autopilot button. The Smart Throttle will then output analog signals to the navigation Vehicle Management System (VMS) that are the resultant of the Port and Starboard PID thrust vector algorithms as seen in FIG. 3.

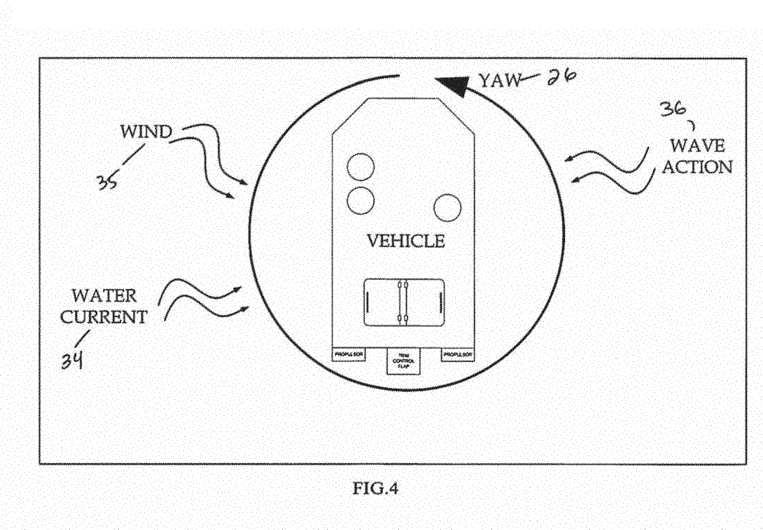

Control for the smart throttle is described in FIGS. 3 and 4. The X, Y and Z axis accelerometer rate and X, Y and Z gyro roll rate are provided to yaw angle rate step 25. The output of the yaw angle rate calculation 25 is provided to the YAPV Yaw angle processor variable) 26. Destination GPS Latitude, Destination GPS Longitude, Current GPS Latitude and Current GPS Longitude are used to calculate Yaw Angle set Point 27. Yaw Angle Set Point 27 is a calculated heading on a great circle current point to destination. Yaw Angle Set Point 27 and YAPV Yaw angle processor variable 26 are combined at summing step 28. Output from summing step 28 is used for determining speed step 29. Speed step 29 incorporates Max speed and distance to destination in conjunction with summing step 28 to determine K distance error and max speed. Heading PID 30 takes speed step 29 information and summing step 28 to produce control and engine commands port propulsor throttle setting 31, starboard propulsor throttle setting 32 and vehicle trim control 33.

Thus, by using a combined 3-axis gyro and 3-axis accelerometer inertial system an actual YAW (heading) angle 26 with respect to North is provided to a PID (Proportional Integral Differential) control system 30 which is executed on the auto pilot computer. This actual YAW (heading) 26 which is influenced by outside natural forces (WATER CURRENTS 34, WIND 35, WAVE ACTION 36) of the vehicle 100 is compared to the desired YAW (heading) 26 which is calculated using the destination Latitude and Longitude and the last known current lat/long while GPS is available and has a low HDOP (Horizontal dilution of precision). A speed and propulsor output is created from the PID's 30 calculations needed to close the error gap between the desired heading and the actual heading.

For example the operator can program the smart throttle 10 to go to a rendezvous point, hit the autopilot, and then leave the vehicle to operate on its own to that destination or in an unmanned mode to rescue a person (such as a downed pilot). Autonomous operation can be enabled with this operation by programming a destination and then enabling the vehicle to travel on its own. This mode would take into account right/left propulsion, known prevailing currents and sea states and standard maritime traffic routes as needed to optimally arrive at the destination.

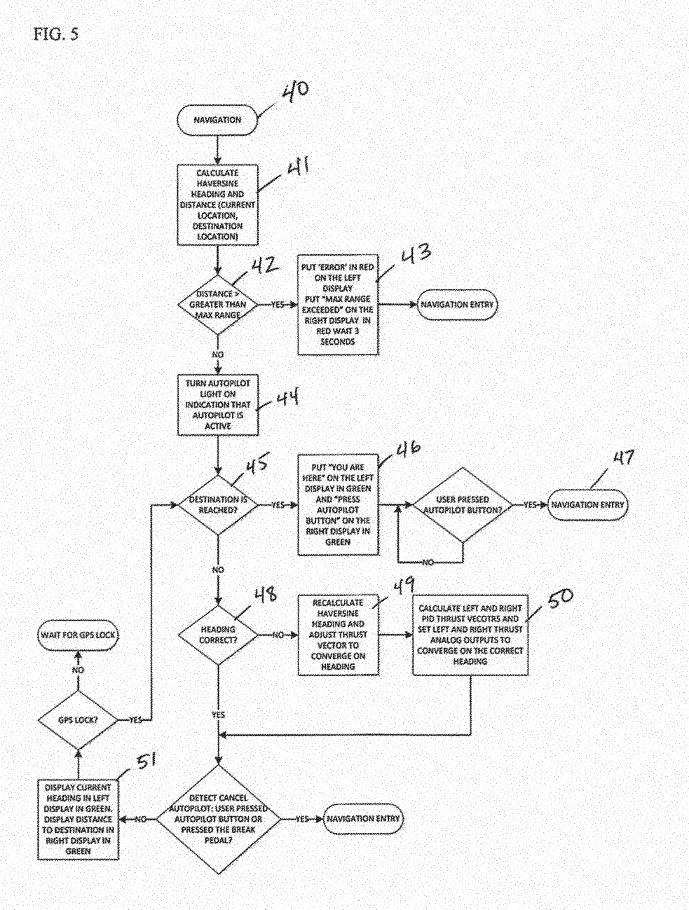

FIG. 5 provides a navigation mode 40 flowchart for using the present invention to autopilot a vehicle 100 to a destination. After an operator has initiated a GPS lock, determined current latitude/longitude and set in a destination the navigation mode 40 in instituted. A bearing calculation 41 using a Haversine formula calculates desired course based on current location. If distance to destination calculation 42 results in a destination beyond vehicle range an error message 43 is displayed. If destination is within range, autopilot indicator 44 is engaged.

The navigation mode 40 then performs a loop that checks to see if destination 45 is reached. If “Yes” then the “you are here” message 46 is displayed and the navigation entry 47 is provided. If “No” then the navigation mode 40 determines a heading correction 48 step. The Haversine heading is recalculated as well the thrust vector calculations 49. Left and Right propulsor and trim are determined 50 to converge on correct heading. The heading correction step 48 continues providing corrected course and displaying current heading and distance to destination 51 until destination is reached.

The magnitude of the correction angle is the difference between current course, and bearing (or desired course). This is a quick and easy way for the pilot to gauge error in their current course. The algorithm finds the most efficient path to correct any error: If the correction angle is positive the pilot should turn “clockwise”. If the angle is negative, the pilot should turn “counter clockwise”.

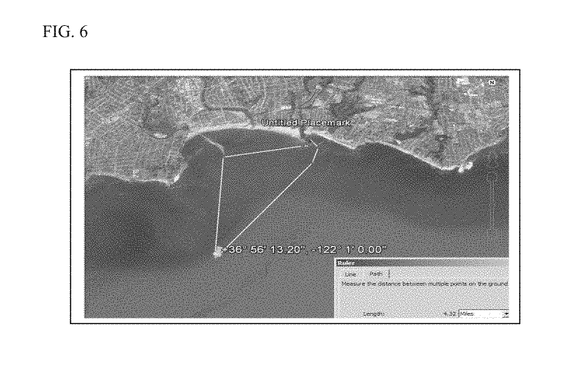

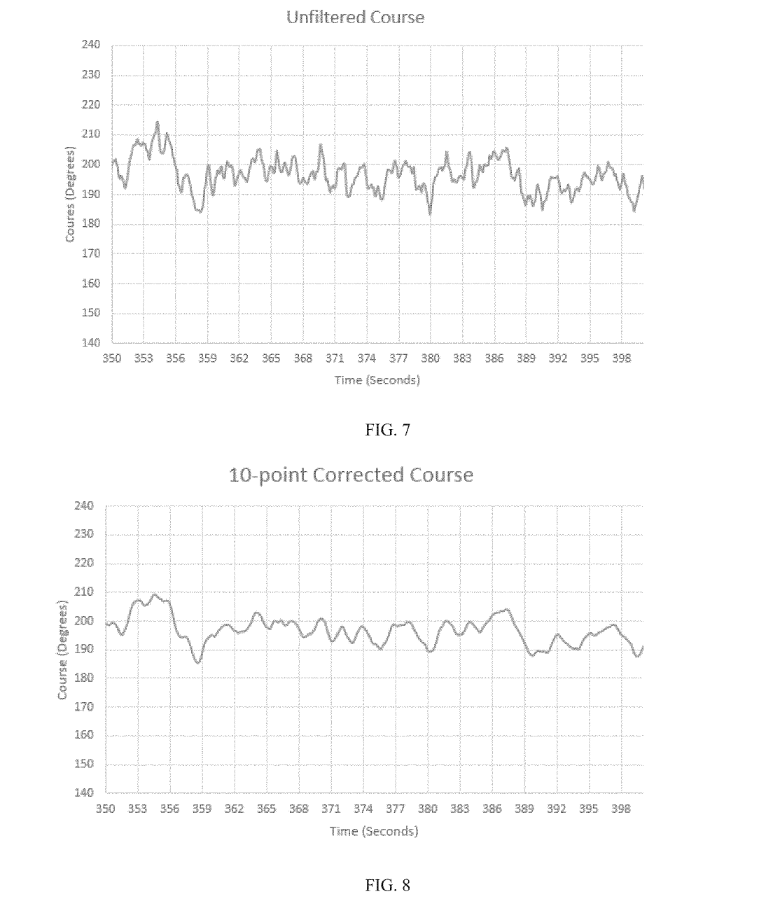

Testing of the present invention is illustrated in FIGS. 6-8. All of the basic navigational functions were verified on water, however due to the “heave” caused by the ocean, the raw heading (course) data received by the GPS became occasionally erratic, thus modulating “course” and “correction angle” to behave erratically for short periods of time. To resolve this, a basic “running average” filter accounts for heave and other oceanic factors. The portion of the trip chosen for this test began with a sharp turn (shown in the first few seconds of the graphs) into a relatively straight path for over 20 minutes of travel. This portion was passed through a filter using 2, 4, and 10 data points. FIGS. 7 and 8 compare the results of unfiltered and filtered course corrections.

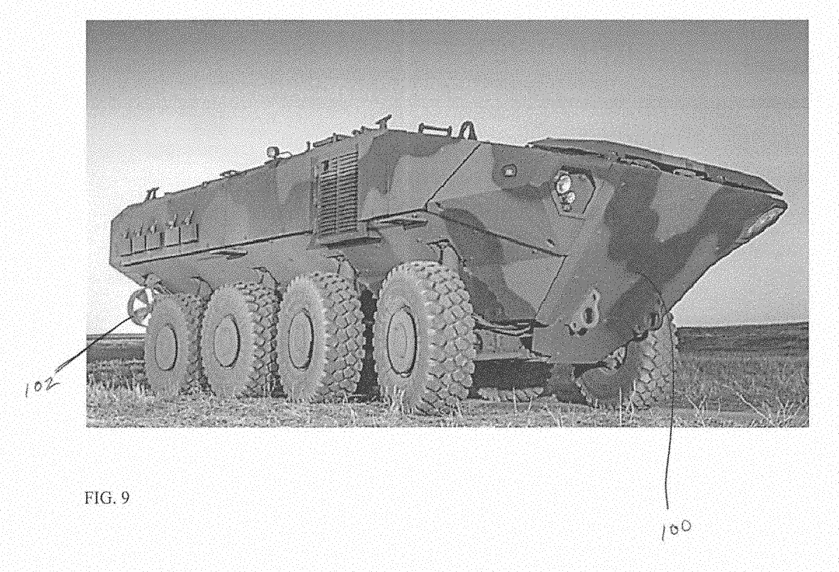

In one embodiment, the Smart Throttle device is used on an amphibious vehicle 100 having multiple propellers 102 as illustrated in FIG. 9.

The present invention allows for more accurate and fuel economical transit from source to destination such as (ship to shore or shore to ship or shore to shore); allows for more accurate night time or obscured visibility transit; and autonomous operation can also be enabled with the is operation by programming a destination and then enabling the vehicle to travel on its own.

The present invention takes advantage of unique knowledge to optimize route selection and speed to account for steer performance characteristics of vehicle which are powered with left and right propulsors. Route and speed algorithms will allow selection to vary from maximal fuel economy to minimum time to destination.

These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A throttle device for an amphibious vehicle having a port and a starboard propulsor, the throttle device including;
a throttle device housing;
a pair of left and right propulsor control paddles attached to the throttle device housing and operably connected to a left and a right propulsor;
an autopilot engagement switch mounted to the throttle device housing;
a manual trim control switch mounted to the throttle device housing; and
a power cord mounted to the throttle device housing and operably connected to an autopilot controller, wherein said autopilot controller is configured to receive a destination and to selectively control the left and right propulsor so as to direct the amphibious vehicle to the destination.

2. The throttle device of claim 1 further including an interface panel for programming the destination into the autopilot controller.

3. The throttle device of claim 2 wherein the interface panel includes a visual display for providing information as to a location and a course.

4. The throttle device of claim 1 further including a cancel autopilot control switch separate from the autopilot engagement switch.

5. The throttle device of claim 1 wherein the autopilot controller determines whether the destination is within a fuel range of the amphibious vehicle.

6. The throttle device of claim 1 wherein the autopilot controller calculates a corrected yaw heading based on a wind effect, a water current effect and a wave action effect.

7. The throttle device of claim 1 wherein the autopilot controller is operably connected to a global positioning system-inertial navigation system.

8. The throttle device of claim 1 includes an antenna connection so that the autopilot controller is operably connected through a wireless connection, a secure High Frequency connection or a satellite communication connection for receiving a commands instruction to allow an unmanned operation of the amphibious vehicle.

9. A method for autopiloting an amphibious vehicle to a destination, the method comprising;
activating a smart throttle having a controller, said smart throttle selectively engaging a left and a right propulsor;
instructing the smart throttle as to the destination;
engaging an autopilot function;
calculating a course to the destination
outputting from the controller a plurality of signals to the left and right propulsors to direct the amphibious vehicle to the destination; and
adjusting the course based on wind, water current and wave action.

10. The method of claim 9 wherein instructing the smart throttle to the destination further includes creating a starting set point.

11. The method of claim 10 further including calculating an amphibious vehicle range and comparing to a distance between the destination and the starting set point.

12. The method of claim 10 wherein the starting set point is based on a destination GPS Latitude, a destination GPS Longitude, a current GPS Latitude and a current GPS Longitude

13. The method of claim 9 wherein adjusting the course includes factoring an X, Y and Z axis accelerometer rate and an X, Y and Z gyro roll rate to determine a current position.

14. The method of claim 12 wherein adjusting the course further includes adjusting a speed of the amphibious vehicle.

15. The method of claim 12 further including comparing the current position to a desired yaw heading, said current position reflecting the influences of water currents, wind and wave action.

16. The method of claim 15 further including altering a command to the left and right propulsors based on comparing the current position to the yaw heading.

17. The method of claim 9 further including controlling a trim control flap on the amphibious vehicle to adjust the course.

18. The method of claim 9 further including disengaging the autopilot function upon reaching a destination.

19. The method of claim 9 further including filtering the adjusting the course to take into account any oceanic factor.

20. The method of claim 19 wherein the filtering is a basic running average filter.
